(19) United States
(12) Patent Application Publication
(10) Pub. No.: US 2025/0088082 A1
(43) Pub. Date: Mar. 13, 2025

(54) METHOD AND DEVICE FOR JOINING A COIL MAT TO A STATOR OF AN EXTERNAL ROTOR MOTOR

(71) Applicant: GROB-WERKE GmbH & Co. KG, MINDELHEIM (DE)

(72) Inventors: Markus SCHMÖLZ, RIEDEN (DE); Manfred ZIEGLER, HILTENFINGEN (DE); Johannes ANSORGE, WINTERRIEDEN (DE)

(21) Appl. No.: 18/826,662

(22) Filed: Sep. 6, 2024

(30) Foreign Application Priority Data
Sep. 8, 2023 (EP) 23196368.7

(51) Int. Cl. H02K 15/085; H02K 15/02; H02K 15/04

(52) U.S. Cl. CPC H02K 15/085; H02K 15/026; H02K 15/043; H02K 2215/00

(57) ABSTRACT

A joining method for joining a coil mat to the stator of an external rotor motor by: providing a coil mat having straight wire sections connected by winding heads, providing a stator with stator slots opening radially outwards, winding up the coil mat on a winding carrier which has radially outwardly opening winding carrier receiving slots, transferring the coil mat from the winding carrier to a transfer tool which has radially inwardly opening transfer tool receiving slots, and transferring the coil mat from the transfer tool to the stator. In addition, a joining device, a control unit and a computer program for carrying out the joining method.

### CROSS-REFERENCES TO RELATED APPLICATIONS

This application claims the benefit of European Patent Application Number 23196368.7 filed on Sep. 8, 2023, the entire disclosure of which is incorporated herein by way of reference.

### FIELD OF THE INVENTION

The invention relates to a joining method for joining a coil mat to a stator of an external rotor motor. The invention also relates to a joining device for joining a coil mat, which has straight wire sections connected by winding heads, in outwardly opening stator slots of a stator of an external rotor motor. The invention also relates to an (electronic) control unit and a computer program for such a joining device.

### BACKGROUND OF THE INVENTION

Reference is made to the following literature for the technological background and prior art:
[1] WO 2019/098949 A1
[2] WO 2019/020148 A1
[3] WO 2019/166060 A1
[4] WO 2019/114570 A1
[5] WO 2017/102981 A1
[6] EN 10 2019 106 711 A1
[7] EP 3 886 303 B1
[8] WO 2018/019970 A1

A method for manufacturing a stator of an external rotor motor is known from [1], in which method a stator with stator slots opening radially outwards is provided and a wire bent in a wave-like or meandering shape is fed tangentially to the stator to form a wave winding and is wound onto a laminated core of the stator. In this way, a wave-shaped wire is inserted directly into the stator in a wind-up process.

This process is significantly improved in terms of process time and automation compared to previous processes for manufacturing stators for external rotor motors, in which process wires are wound around the teeth of the stator.

### SUMMARY OF THE INVENTION

Based on [1], an object of the invention is to provide improved methods and devices for joining a coil winding to a stator of an external rotor motor.

This object may be achieved by the invention providing a joining method and a joining device according to one or more embodiments. Furthermore, a control system and a computer program for such a joining device are also disclosed.

According to one aspect thereof, the invention provides a joining method for joining a coil mat to a stator of an external rotor motor, the method comprising:
a) providing a coil mat having straight wire sections connected by winding heads,
b) providing a stator with stator slots opening radially outwards,
c) winding up the coil mat on a winding carrier which has radially outwardly opening winding carrier receiving slots into which the straight wire sections are inserted,
d) transferring the coil mat from the winding carrier to a transfer tool which has radially inwardly opening transfer tool receiving slots, the winding carrier receiving slots being aligned with the transfer tool receiving slots and the straight wire sections being transferred from the winding carrier receiving slots into the transfer tool receiving slots, and
e) transferring the coil mat from the transfer tool to the stator, with the transfer tool receiving slots being aligned with the stator slots and the straight wire sections being transferred from the transfer tool receiving slots radially inwards into the stator slots.

Preferably, step a) comprises the step:
a1) bending wires with a substantially rectangular cross-section and an outer insulating layer into wave winding wires.

Preferably, step a) comprises the step:
a2) joining together a plurality of wave winding wires which are formed in a meandering shape with straight wire sections and winding heads bent in different directions therebetween.

Preferably, step a) comprises the step:
a3) producing the coil mat by winding, stacking, braiding or pinning a plurality of wires.

Preferably, step a) comprises the step:
a4) providing the coil mat on an elongate holder having a series of teeth with gaps between the teeth, such that the straight wire portions of the coil mat are received in the gaps between the teeth.

Preferably, step b) comprises the step:
b1) providing a laminated core with radially outwardly opening stator slots.

Preferably, step b) comprises the step:
b2) lining the stator slots with slot insulation.

Preferably, step b) comprises the step:
b3) inserting insulation papers into the stator slots.

Preferably, step b) comprises the step:
b4) covering slot edges with Z-shaped or Omega-shaped slot insulation.

Preferably, step c) comprises the step:
c1) providing the winding carrier with a diameter equal to or greater than the diameter of the stator.

The term “equal” in step c1) and in step c6) explained further below is to be understood in the sense of “substantially equal”; diameters that differ slightly (e.g. 10%) from one another are still to be understood as “equal” in this sense.

Preferably, step c) comprises the step:
c2) providing the winding carrier with radially movable ejector elements for radially ejecting the coil mat from the winding carrier receiving slots.

Preferably, step c) comprises the step:
c3) providing an arrangement of radially movable support fingers axially adjacent to slot boundaries of the winding carrier receiving slots.

Preferably, step c) comprises the step:
c4) providing the winding carrier with radially movable winding carrier slot limiting elements.

Preferably, step c) comprises the step:
c5) picking up the coil mat from a linearly extending holder while rotating the winding carrier and relatively linearly moving the winding carrier and the holder.

Preferably, step c) comprises the step:
c6) winding up the coil mat on the winding support with a wind-up diameter which is equal to or greater than the coil diameter of the coil mat subsequently inserted into the stator.

Preferably, step d) comprises the step:
d1) providing the transfer tool with an annular arrangement of radially immovable or radially movable transfer tool slot limiting elements.

Preferably, step d) comprises the step:
d2) providing radially movable support fingers axially adjacent to slot boundaries of the transfer tool receiving slots.

Preferably, step d) comprises the step:
d3) radially moving the straight wire sections from the winding carrier receiving slots into the transfer tool receiving slots.

Preferably, step d) comprises the step:
d4) radially expanding the coil mat during transfer from the winding carrier to the transfer tool by means of radially outwardly moving ejector elements.

Preferably, step d) comprises the step:
d5) transferring the coil mat while maintaining the coil mat shape and/or the coil mat diameter by radially moving slot limiting elements of the winding carrier and the transfer tool.

Preferably, step d) comprises the step:
d6) supporting and/or guiding the coil mat during transfer by means of radially feedable support fingers.

Preferably, step d) comprises the step:
d7) holding the coil mat on the winding heads during transfer.

Preferably, step e) comprises the step:
e1) radially compressing the coil mat during transfer onto the stator.

Preferably, step e) comprises the step:
e2) guiding the coil mat during transfer by means of support fingers. Preferably, step e) comprises the step:
e3) holding slot insulations in place when transferring the coil mat onto the stator.

Preferably, step e) comprises the step:
e4) clamping slot insulations by means of support fingers.

Preferably, step e) comprises the step:
e5) holding slot insulations in place by means of radial slot limiting elements of the transfer tool.

Preferably, step e3), e4) and/or e5) is followed by step e6) of releasing the slot insulations during the process, in particular during an insertion of the straight wire sections, in order to enable a transfer of the slot insulations together with the straight wire sections down to the bottom of the slots.

According to a further aspect, the invention provides a joining device for joining a coil mat which has straight wire sections connected by winding heads into outwardly opening stator slots of a stator of an external rotor motor, comprising:
a winding carrier which has an annular arrangement of radially outwardly opening winding carrier receiving slots and on which the coil mat can be wound up under insertion of the straight wire sections into the winding carrier receiving slots; and
   a transfer tool which has an annular arrangement of inwardly opening transfer tool receiving slots and which is designed to receive the coil mat from the winding carrier and transfer it to the stator.

Preferably, the joining device further has
a rectilinear holder with at least one row of teeth for providing the coil mat and
a wind-up device for rotating the winding carrier and for relative movement of the winding carrier and holder for winding up the coil mat on the winding carrier.

It is preferred that the winding carrier has radially fixed or radially movable winding carrier slot limiting elements.

It is preferred that the winding carrier has radially movable ejector elements for radially ejecting the coil mat for transfer to the transfer tool.

It is preferred that the winding carrier is held on a winding carrier handling device that is arranged to insert the winding carrier with wound-up coil into the transfer tool and to align the receiving slots of the winding carrier and the transfer tool with each other for transferring the coil mat.

It is preferred that the transfer tool has radially fixed or radially movable transfer tool slot limiting elements.

It is preferred that the transfer tool is held on a transfer tool handling device that is arranged to align the transfer tool with the winding carrier and the stator for the respective transfer of the coil mat.

In some embodiments, the joining device has at least one annular arrangement of radially movable support fingers for supporting and/or guiding the coil mat during transfer from the winding carrier to the transfer tool and/or during transfer from the transfer tool to the stator.

It is preferred that the arrangement of support fingers is arranged to clamp slot insulations inserted in stator slots to the stator when transferring the coil mat from the transfer tool to the stator.

Preferably, the joining device has a control unit with at least one processor and at least one memory adapted to control the joining device for carrying out the joining process according to one of the preceding configurations.

According to a further aspect thereof, the invention provides a control unit for a joining device according to one of the preceding embodiments, wherein the control unit is adapted to control the joining device for carrying out the joining process according to one of the preceding embodiments.

According to a further aspect thereof, the invention provides a computer program comprising instructions for causing a joining device according to one of the preceding embodiments to perform the joining method according to one of the preceding configurations.

Preferred embodiments of joining methods and joining devices are designed for the industrial mass production of stators of external rotor motors. As in [1], they are characterized by short process times and good automation capability.

An external rotor motor (also known as an external rotor for short) is a type of rotating electrical machine in which the stationary part (stator) of the machine is located inside and is enclosed by the moving part (rotor). Depending on the operating point and design, the machine can be used as an electric generator or as an electric motor. The preferred use of the external rotor motors that can be produced using methods and devices according to preferred embodiments of the invention is electromobility. For example, external rotor motors are to be manufactured in industrial mass production to be used as traction motors or traction drives for electrically powered vehicles (e.g. battery electric vehicles, hybrid vehicles or vehicles with fuel cells), such as in particular passenger cars or trucks. External rotor motors can be used, for example, as wheel hub motors for direct drive.

In particular, external rotor motors with high performance are to be manufactured. For this purpose, coil windings made of wires with a rectangular cross-section are particularly advantageous in order to achieve a high filling level.

Preferred embodiments are designed for stator production with wave winding. In this technology, which is generally known for stators of internal rotor motors, at least one prefabricated wire mat (prefabricated outside the stator)—referred to here as a coil mat—is inserted into the stator. A “coil mat” is understood to be a mat-shaped structure made of wave-shaped wires. A coil mat has a plurality of straight wire sections that are connected to each other by roof-shaped bent wire sections-winding heads. Such coil mats can be prefabricated in various ways, such as sword winding, stacking or pinning. Manufacturing methods for the coil mats are known and described in detail for instance from literature [2] and [3] as well as the documents cited in [2] and [3].

As described in [1], it is obvious for the production of stators for external rotor motors to attach prefabricated coil windings, such as individual wave winding wires, directly to the arrangement of outwardly opening slots of a laminated core of an external rotor stator. It is common practice to cover the slots with insulating paper beforehand.

In detail, however, there are difficulties with this technology, in particular the risk of damage to the wire and/or slot insulation paper. Due to the geometric conditions, the wires or insulation cannot be protected during direct wind-up of wave winding wires, or only with great effort. In particular, the sharp edges of the laminated core can very easily damage the wire-especially its outer insulating layer. In addition, the wire can displace the paper into the groove and damage it.

Preferred embodiments of joining methods and joining devices according to the invention are further improved over prior art according to [1] in terms of process reliability, reduction of rejects and/or reduction of damage to the coil winding.

Preferred embodiments of the invention relate to the manufacture of a stator for an external rotor (motor) with wave winding. In the wave winding concept, so-called winding mats (here called coil mats) are produced and then inserted into the laminated core.

Preferred embodiments relate to a concept for a series system for external rotor stators.

Preferred embodiments create a possibility (process or device) for joining the windings (in the form of a prefabricated wave winding or coil mat) to the stator with as little damage as possible or at least with a reduced risk of damage.

In an advantageous process according to embodiments of the invention and in combination with a transfer tool, component damage to the outer rotor can be reduced to a minimum and proven processes—in the field of manufacturing stators for inner rotor (motors)—can be used.

Some embodiments of the method have the following sequence of steps:

### Step 1:

The wires/windings are wound onto a winding carrier (as for an internal rotor). In some embodiments, the diameter can (but does not have to) correspond to the stator diameter.

### Step 2:

From this winding carrier, the wires are transferred (expanded) to a special transfer tool

### Step 3:

The wires are joined (compressed) radially onto the stator by the transfer tool.

Simple elements can be inserted to protect the components. This reduces damage.

Other embodiments of the method have the following sequence of steps:

### Step 1:

The wires/windings are wound onto a winding carrier (as with an internal rotor). The (winding) diameter is larger than the stator diameter so that additional expansion to a transfer tool is not necessary.

### Step 2:

The wires are transferred from this winding carrier to a special transfer tool (without wire deformation).

### Step 3:

The wires are joined (compressed) radially onto the stator by the transfer tool.

Simple elements can be inserted to protect the components. This reduces damage. In addition, the necessary deformation of the wires is reduced to a minimum.

### BRIEF DESCRIPTION OF THE DRAWINGS

Examples of embodiments of the invention are explained in more detail below with reference to the accompanying drawings.

FIG. 1 is a simplified schematic view of an exemplary embodiment of a coil mat;

FIG. 2 is a simplified schematic block diagram of a joining device for joining the coil mat to a stator of an external rotor;

FIG. 3 is a schematic side view (in axial direction) of a winding carrier of the joining device according to a first embodiment;

FIG. 4 is an enlarged detailed view of a partial area of the winding carrier of FIG. 3;

FIG. 5 is a schematic side view (in axial direction) of a transfer tool of the joining device according to a first embodiment;

FIG. 6 is a schematic side view (in axial direction) of an exemplary embodiment of a stator of an external rotor onto which windings/wires have been inserted with the aid of the transfer tool according to FIG. 5 or according to FIG. 22;

FIG. 7 is a schematic perspective view of a design of the transfer tool together with an annular arrangement of radially movable support fingers;

FIG. 8 is a schematic side view of a lower area of a further exemplary embodiment of the winding carrier during winding of the coil mat;

FIG. 9 is a schematic side view of an embodiment variant of the winding carrier together with a linear workpiece holder when picking up the coil mat;

FIG. 10 is a schematic side view of the joining device according to the first embodiment in a situation in which the winding carrier is inserted into the transfer tool and before the coil mat is transferred;

FIG. 11 is a view as in FIG. 10 after the coil mat has been transferred from the winding carrier to the transfer tool;

FIG. 12 is an enlarged detail from FIG. 11 with an illustration of the movement of ejector elements and the coil mat during transfer;

FIG. 13 is a perspective view of the design variant of the transfer tool with the arrangement of support fingers according to FIG. 7, which shows how the support fingers support the transfer of the coil mat from the winding carrier to the transfer tool as shown in FIGS. 11 and 12;

FIG. 14 is a schematic side view of the stator inserted into the transfer tool before transferring the coil mat from the transfer tool to the stator;

FIG. 15 is an enlarged detail from FIG. 14, in which the movement of the wires or windings of the coil mat from the transfer tool to the stator is indicated;

FIG. 16 is a representation as in FIG. 14 after the coil mat has been transferred to the stator;

FIG. 17 is a perspective view of the embodiment variant of the transfer tool with the arrangement of support fingers according to FIG. 7, which shows how the support fingers support the transfer of the coil mat from the transfer tool to the stator;

FIG. 18 is a schematic perspective view of an arrangement of stator and transfer tool with support fingers in a further embodiment variant, wherein only one of the support fingers is shown for illustration purposes and the coil mat is not shown;

FIG. 19 is an enlarged detail from FIG. 18;

FIG. 20 is a schematic side view (in axial direction) of the winding carrier of the joining device according to a second embodiment;

FIG. 21 is an enlarged detailed view of a partial area of the winding carrier of FIG. 20;

FIG. 22 is a schematic side view (in axial direction) of the transfer tool of the joining device according to a second embodiment;

FIG. 23 is an enlarged detailed view of an area of FIG. 22;

FIG. 24a is a side view of a portion of the joining device according to the second embodiment in a situation in which the winding carrier of FIGS. 20 and 21 is concentrically inserted into the transfer tool of FIGS. 22 and 32 during a first stage of a transfer of the coil mat from the coil carrier to the transfer tool;

FIG. 24b is a side view of a portion of the joining device according to the second embodiment in a situation in which the winding carrier of FIGS. 20 and 21 is concentrically inserted into the transfer tool of FIGS. 22 and 32 during a second stage of a transfer of the coil mat from the coil carrier to the transfer tool;

FIG. 24c is a side view of a portion of the joining device according to the second embodiment in a situation in which the winding carrier of FIGS. 20 and 21 is concentrically inserted into the transfer tool of FIGS. 22 and 32 during a third stage of a transfer of the coil mat from the coil carrier to the transfer tool;

FIG. 25 is a side view of the joining device according to the second embodiment with the winding carrier inserted concentrically into the transfer tool during the first stage of the transfer shown in FIG. 24a;

FIG. 26 is a side view of the joining device according to the second embodiment with the winding carrier inserted concentrically into the transfer tool at the second stage of the transfer shown in FIG. 24b;

FIG. 27 is a side view of the joining device according to the second embodiment with the winding carrier inserted concentrically into the transfer tool at the third stage of the transfer shown in FIG. 24c;

FIG. 28 is a side view of an arrangement of a transfer tool according to the second embodiment and the stator of the external rotor before a transfer of the coil mat onto the stator; and

FIG. 29 is a detailed view of FIG. 28, in which the movement of the wires or windings during the transfer is shown.

### DETAILED DESCRIPTION OF THE PREFERRED EMBODIMENTS

In the following, embodiments of a joining method and a joining device 10 for joining a coil mat 12 to a stator 14 of an external rotor motor are explained with reference to the accompanying drawings.

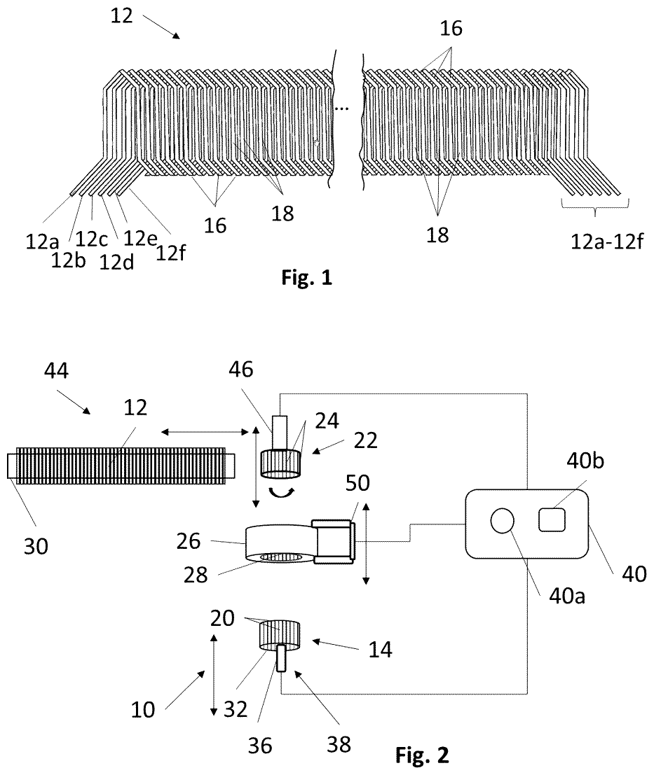

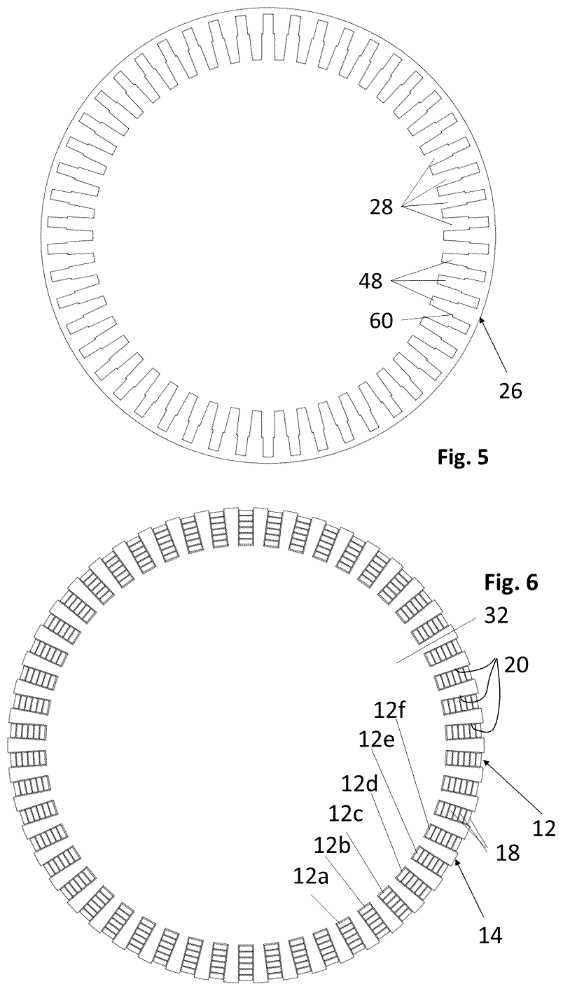

With reference to FIGS. 1, 2, 6, 8, 12, 24a-24c, 15 and 29, the joining method comprises the steps:
a) providing a coil mat 12 having straight wire sections 18 connected by winding heads 16,
b) providing a stator 14 with stator slots 20 opening radially outwards,
c) winding up the coil mat 12 on a winding carrier 22 which has radially outwardly opening winding carrier receiving slots 24 into which the straight wire sections 18 are inserted,
d) transferring the coil mat 12 from the winding carrier 22 to a transfer tool 26 which has radially inwardly opening transfer tool receiving slots 28, the winding carrier receiving slots 24 being aligned with the transfer tool receiving slots 28 and the straight wire sections 18 being transferred from the winding carrier receiving slots 24 into the transfer tool receiving slots 28, and
e) transferring the coil mat 12 from the transfer tool 26 to the stator 14, wherein the transfer tool receiving slots 28 are aligned with the stator slots 20 and the straight wire sections 18 are transferred radially inwardly from the transfer tool receiving slots 28 into the stator slots 20.

An example of the coil mat 12 to be provided is shown in FIG. 1. The coil mat 12 is prefabricated outside the stator 14 from at least one or preferably—as shown—several wave-like bent wires 12a-12f. Examples of manufacturing processes for prefabricating the coil mat 12 and possible basic designs of the coil mat 12 are known from literature [2] and [3]. Accordingly, the coil mat 12 can be produced from the wires 12a-12f, for example by winding, such as sword winding, stacking, pinning or braiding. The coil mat 12 is first designed on the basis of the desired configuration of the later coil winding in the stator 14 and then preferably manufactured from rectangular wire with an insulating layer in industrial mass production. In particular, the coil mat 12 is provided on a rectilinear holder 30, as is generally known from [6] and [7].

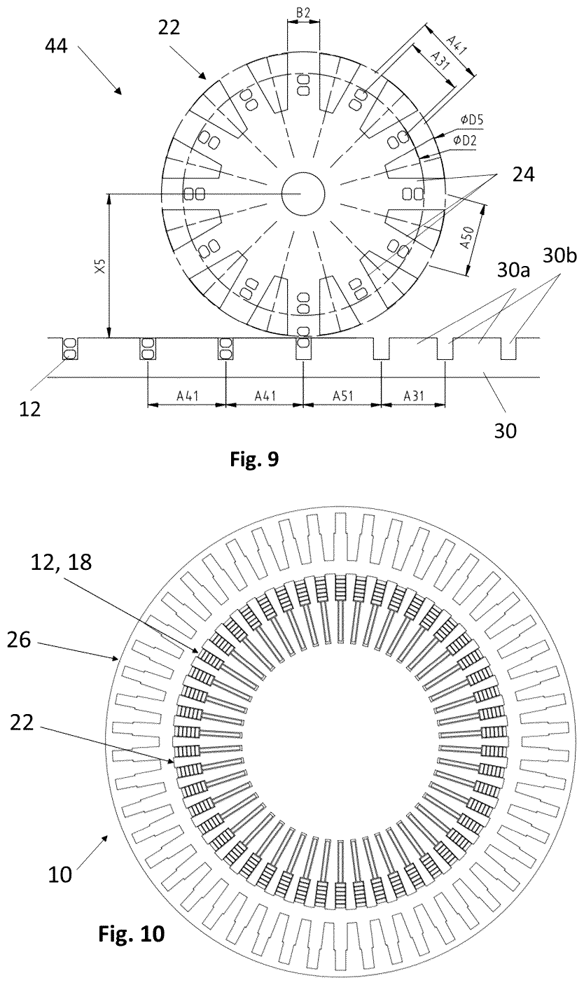

As indicated in FIG. 9, the elongate holder 30 may have a series of teeth 30a with gaps 30b between them, so that the straight wire sections 18 of the coil mat 12 are accommodated in the gaps 30b.

In some embodiments, the distances between the straight wire sections 18 are already selected according to the planned radial position of the wire sections 18 in the stator 14. Distances A41, A51, A31 between the tooth gaps 30b can be correspondingly designed differently.

Examples of embodiments for the stator 14 are shown schematically in FIGS. 2, 6, 6, 14-16, as well as 18 and 19. The stator 14 has—as is generally well known—a laminated core 32, on the outer circumference of which the arrangement of outwardly opening stator slots 20 is formed.

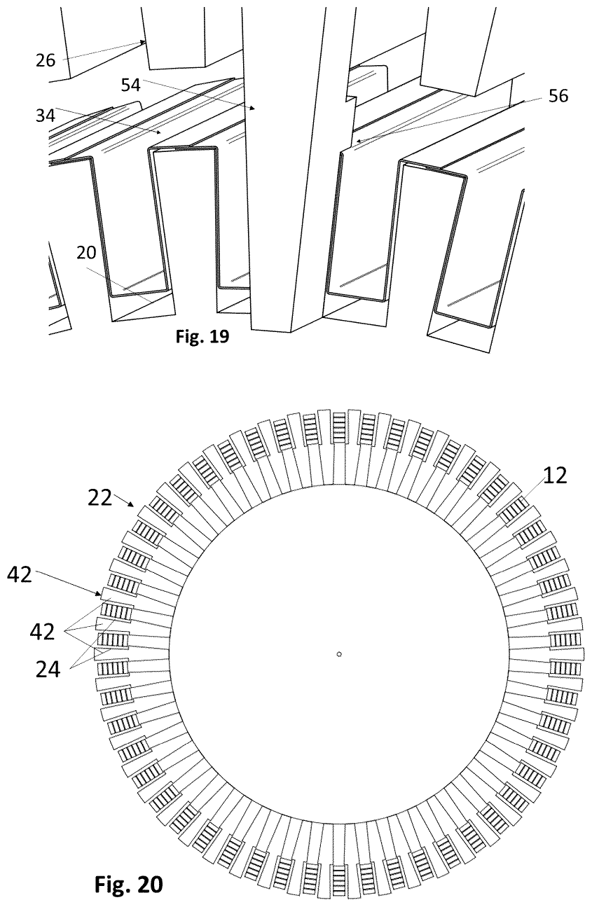

As can be seen in particular from FIGS. 18 and 19, the stator 14 is provided in particular with slot insulations 34. For this purpose, insulating papers are inserted into the stator slots 20 beforehand. Devices and methods for inserting insulation papers are known for internal rotor stators from literature [4] and [5]. These known technologies can easily be used to provide the pre-insulated stator slots 20 shown in FIGS. 18 and 19 by modifying them accordingly to adapt them to the changed geometry of external rotor stators with outwardly opening stator slots 20. In particular, slot edges on the stator slots 20 are covered with Z-shaped or Omega-shaped slot insulations 34.

According to FIG. 2, the stator 14 prefabricated in this way is provided in particular on a stator holder 36. The stator holder 36 can be stationary or can be movably arranged on a stator handling device 38—e.g. robot arm, conveyor belt, portal system,

A schematic overview of an embodiment of the joining device 10 for carrying out the joining process is shown in FIG. 2. The joining device 10 is designed for joining the coil mat 12, which has straight wire sections 18 connected by winding heads 16, into the outwardly opening stator slots 20 of the stator 14 of an external rotor motor.

The joining device 10 has the winding carrier 22 and the transfer tool 26.

In some embodiments, the joining device 10 further comprises an electronic, in particular computer-implemented control unit 40 with a processor 40a and a memory 40b, in which a computer program with instructions for carrying out the joining method is stored.

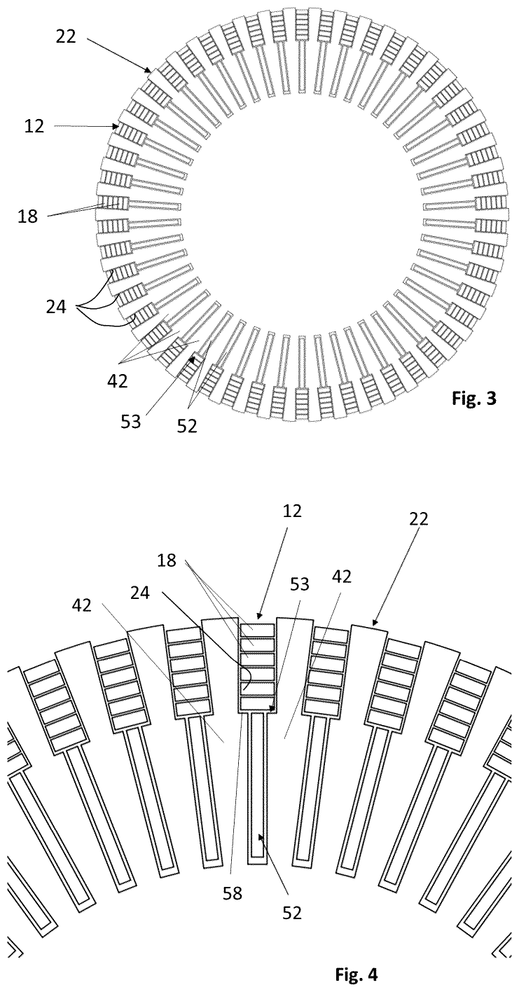

Examples of embodiments of the winding carrier 22 are shown in FIGS. 3, 4, 8, 9 as well as 20 and 21. Accordingly, the winding carrier 22 has an annular arrangement of radially outwardly opening winding carrier receiving slots 24, such that the coil mat 12 can be wound up under insertion of the straight wire sections 18 into the winding carrier receiving slots 24. The winding support receiving slots 24 are bounded by winding carrier slot limiting elements 42. The design of the winding carrier slot limiting elements 42 can be very different. In particular, joining mandrels can be provided as winding carriers 22, as are known for joining coil mats in internal rotor stators, for example from literature [6], [7] or [8].

For winding up the coil mat 12, some embodiments of the joining device 10 have a wind-up device 44, examples of which are shown in FIGS. 2, 8 and 9. In particular, the winding carrier 22 is arranged on a winding carrier handling device 46 which can be controlled by the control unit 40 and by means of which the winding carrier 22 can be moved linearly relative to the holder 30 and can be set in rotation in order to wind up the coil mat 12. In some embodiments, the winding carrier handling device 46, as indicated by the double arrow, is arranged to move the winding carrier 22 towards the transfer tool 26 in order to transfer the coil mat 12 onto the transfer tool 26.

Winding up the coil mat 12 on the winding carrier 22 and designs of the winding carrier 22 are known for methods for joining coil mats to internal rotor stators from literature [6] and [7]. The same technologies can also be used here.

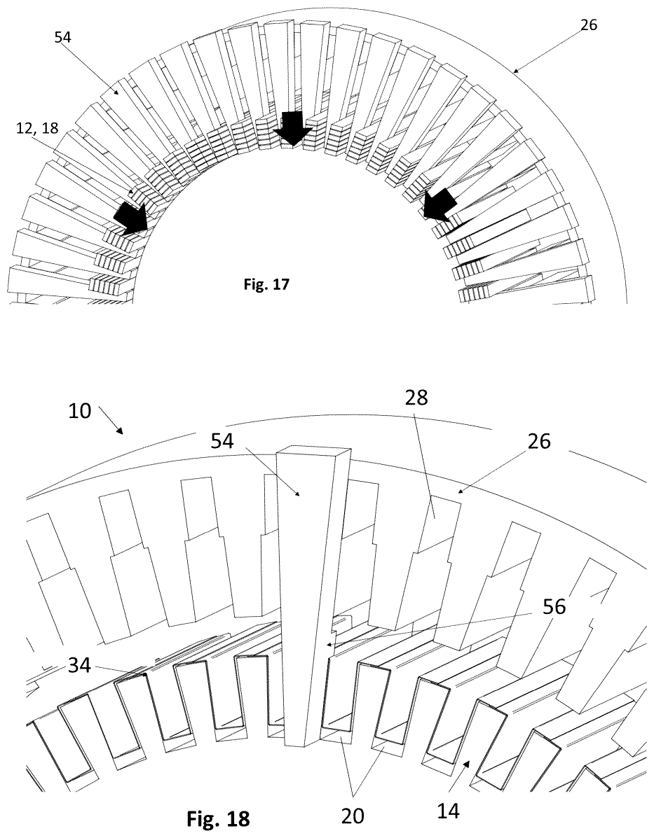

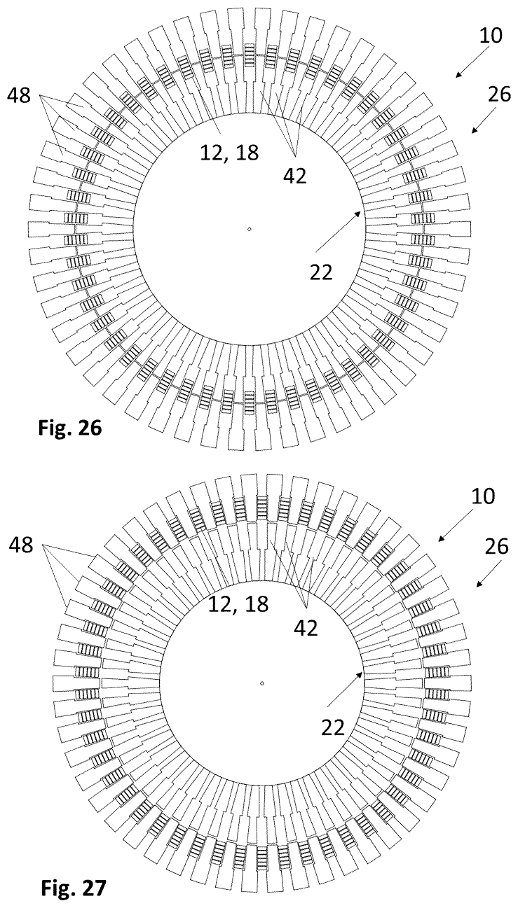

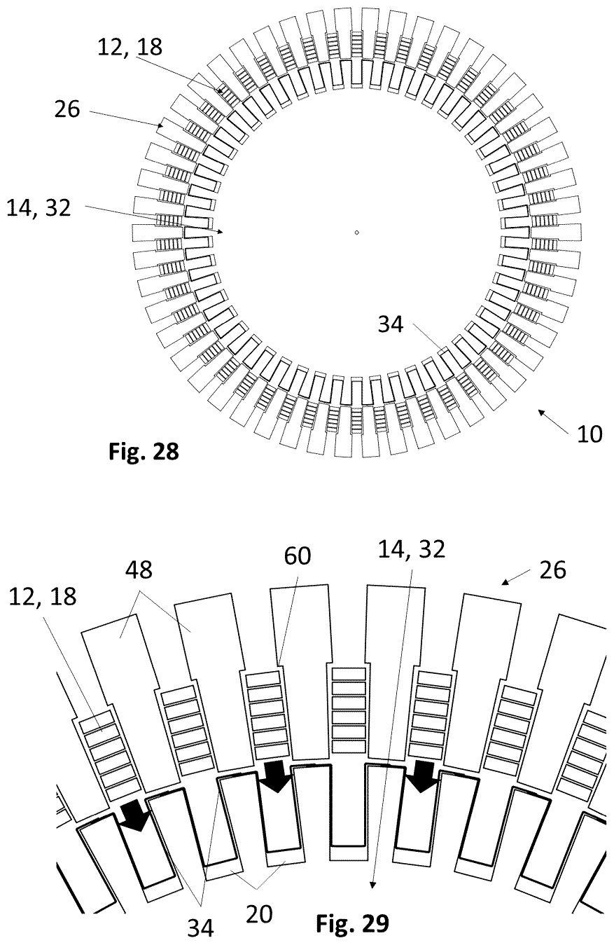

Examples of embodiments of the transfer tool 26 are shown in FIGS. 2, 5, 7, 10-16, 17, 18 and 19 and 22-29. The transfer tool 26 has the annular arrangement of inwardly opening transfer tool receiving slots 28 and is arranged to receive the coil mat 12 from the winding carrier 22 and transfer it to the stator 14. The transfer tool receiving slots 28 are each bounded by transfer tool slot limiting elements 48.

In some embodiments, the transfer tool 26 is arranged in particular on a transfer tool handling device 50 which can be controlled by the control unit 40 and by means of which the transfer tool 26 can be moved relative to the winding carrier 22 and the stator holder 36 with the stator 14. In some other embodiments, the transfer tool 26 is held stationary and the relative movements of the winding carrier 22, transfer tool 26 and stator holder 36 are performed by moving the winding carrier 22 by means of the winding carrier handling device 46 or by moving the stator handling device 38.

Examples of the handling devices 38, 46, 50 are robot arms, linear transport systems and portal systems. The handling devices 38, 46, 50 can have further actuators that can be controlled by the control system 40, in particular for the controlled radial movement of individual elements of the winding carrier 22 or transfer tool 26 or stator holder 36.

In the following, a first embodiment of the joining device 10 and a joining method that can be carried out with it is explained in more detail with reference to the illustration in FIGS. 3 to 19.

According to FIGS. 3 and 4, the winding carrier slot limiting elements 42 of the winding carrier 22 are arranged or held rigidly or stationary according to the first embodiment. For example, the winding carrier 22 has an outer diameter that is (substantially) equal to the stator diameter. In some embodiments, the diameter of the winding carrier 22 is larger than the stator diameter. In principle, the diameter of the winding carrier 22 can also be smaller than the stator diameter, but this is less preferred, as this leads to more deformation steps for the coil mat 12 during the process.

The winding carrier 22 also has at least one ejector element 52 between adjacent winding carrier slot limiting elements 42, which ejector element is radially movable under the control of the control unit 40 in order to eject the coil mat 12 radially during subsequent transfer to the transfer tool 26. For example, the ejection elements 52 are radially movable expanding plates.

In particular, the ejection elements 52 can be moved radially from their rest position, in which they are retracted at least to the radial height of a slot base 53 of the respective winding carrier receiving slot 24 or further radially inwards, into an ejection position for complete ejection of the straight wire sections 18 from the winding carrier receiving slots 24 and for transfer into transfer tool receiving slots 28 and back again by means of an actuator with a corresponding transmission (not shown) controlled by the control unit 40. Examples of such radially movable elements are known to the skilled person from wave winding technology for internal rotor stators, see e.g. [6]-[8].

According to FIG. 5, the transfer tool 26 of the first embodiment is annular or sleeve-shaped with an internal diameter such that the stator 14 can be accommodated with little play between them. The transfer tool slot limiting elements 48 are, for example, rigid rib-like projections projecting radially inwards.

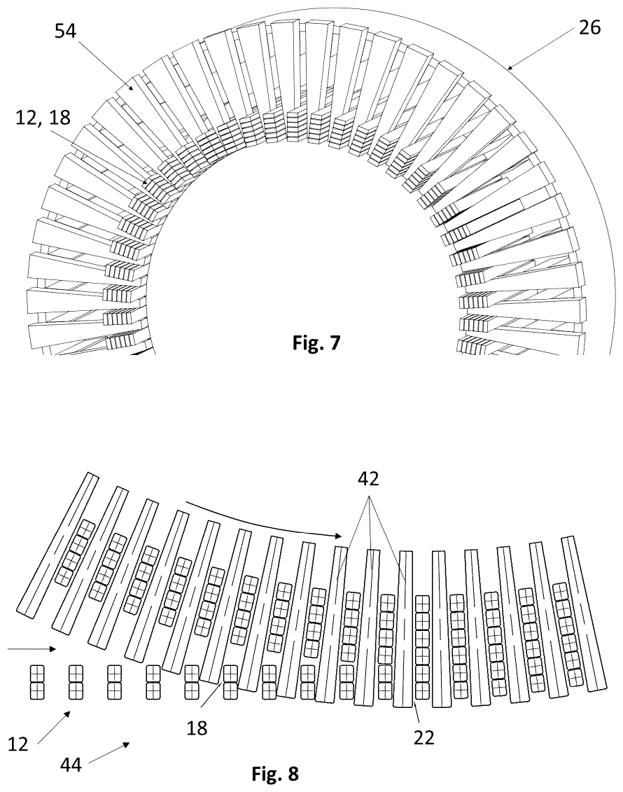

In some embodiments, an example of which is shown in FIG. 7, an annular arrangement of radially movable support fingers 54 is provided on each axial side of the transfer tool 26.

In particular, a support finger 54 is provided on each axial side of each transfer tool slot boundary element 48. In some embodiments, the support fingers 54 are wedge-shaped. The support fingers 54 are configured to guide the wire sections 18 during insertion of the wire sections 18 into the transfer tool receiving slots 28 and during transfer of the wire sections 18 from the transfer tool receiving slots 28 into the stator slots 20. For this purpose, the support fingers 54 are radially movable under the control of the control unit 40. In particular, the support fingers 54 can move together with the wire sections 18 over at least a partial distance. Here too, corresponding actuators controlled by the control unit 40, for example a transmission, can be provided (not shown).

In some embodiments, an example of which is shown in FIGS. 18 and 19, the support fingers 54 are designed to hold and/or clamp the slot insulations 34. For example, the support fingers 54 have a projection 56 on the side facing the transfer tool slot boundary element 48, which projection can move onto the stator slot boundaries 58 between the stator slots 20 by a radially inward movement of the support finger 54 for transferring the coil mat 12 to the stator 14 and can thus clamp the slot insulations placed over the slot edges of the stator slots 20. The slot insulations 34 can be released again by a corresponding counter-movement in order to compress the wires together with the slot insulations (paper) 34 completely to the slot base of the stator slot 20.

The sequence of the joining process according to the first embodiment is explained in more detail below with reference to the illustrations in FIGS. 2, 8, 9, 3, 4 and 10 to 19.

In a first step, the coil mat 12 is wound up on the winding carrier 22. Winding up is carried out as explained in [6] or [7] and shown in FIGS. 8 and 9. The winding carrier 22 and holder 30 with coil mat 12 provided on it are moved linearly relative to each other. For example, the holder 30 can be moved in the longitudinal direction towards the winding carrier 22 or the winding carrier 22 is moved linearly over the holder 30 by means of the winding carrier handling device 46, or both movements take place. In the process, the winding carrier 22 is rotated. By means of support elements not shown, such as curved ramps or other guides or belts or the like, which engage the winding heads 16, the coil mat 12 is lifted off the holder 30 and placed on the winding carrier 22 in such a way that the straight wire sections 18 are inserted into the winding carrier receiving slots 24. The winding diameter can (but does not have to) correspond to the subsequent coil diameter on the stator 14.

The holder 30, for example in the form of a rake, and the winding carrier 22 can be adapted to the previously designed shape of the coil mat 12 by special geometries, as shown in FIG. 9, so that wire damage is reduced.

In a second step, the winding carrier 22 is inserted concentrically into the transfer tool and the winding carrier receiving slots 24 are aligned with the transfer tool receiving slots 28, as shown in FIG. 10. This is done by means of one or more of the handling devices 46, 50, controlled by the control unit 40.

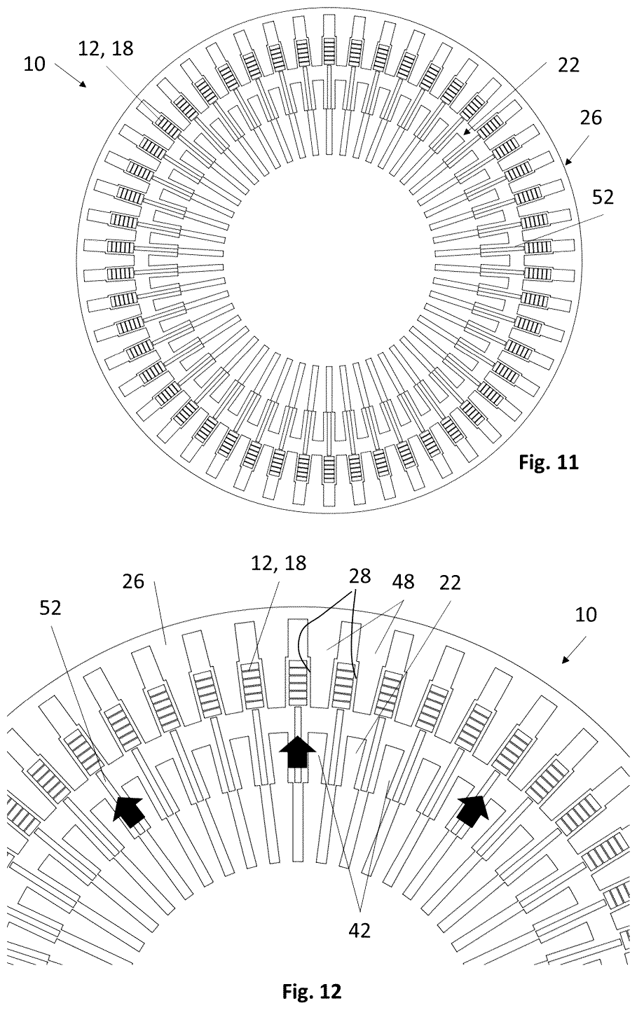

Then, as shown in FIGS. 11 to 13, the coil mat 12 is transferred from the winding carrier 22 to the transfer tool 26. For this purpose, the coil mat 12 is expanded as indicated by the arrows in FIG. 12, i.e., enlarged from a smaller wind-up diameter, with which the coil mat 12 is located on the winding carrier 22, to a larger take-up diameter, with which the coil mat 12 is located in the transfer tool 26.

The expansion takes place in particular by a radially outward movement of the ejector elements 52.

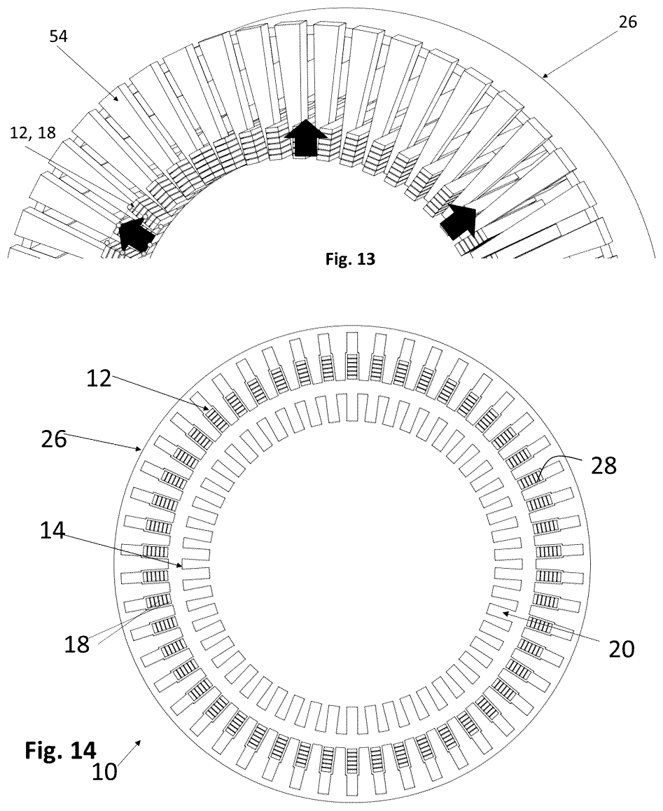

If the slot limiting elements 42, 48 of the winding carrier 22 and transfer tool 26 are close together, the expansion can also be carried out without additional guides. Preferably, the expanding is guided by the support fingers 54 as shown in FIG. 13, which are moved to a radially inwardly extended guide position before the expanding and are held there during the expanding in some embodiments. In some embodiments, the support fingers can also be moved along with the wires 12a-12f.

This results in the situation shown in FIG. 11, in which the straight wire sections 18 are completely received in the transfer tool receiving slots 26.

In a third step, which is shown in FIGS. 14 to 19, the coil mat 12 is transferred from the transfer tool 26 to the stator 14.

For this purpose, the stator 14 and the transfer tool 26 are arranged concentrically to each other by means of one or more of the handling devices 38, 50, so that their slots 20, 28 are aligned with each other, as shown in FIG. 14.

The wires 12a-12f are then transferred from the transfer tool 26 to the stator 14 by means of radially movable grippers, belts or sliders, not shown, which engage on the axially outwardly projecting winding heads 16, whereby the wire sections 18 are inserted into the receiving grooves. In the process, the coil mat 12 is compressed, i.e., its diameter is reduced from a larger receiving diameter, with which it is received in the transfer tool 26, to a smaller coil diameter, which the coil mat 12 assumes on the stator 14 as intended.

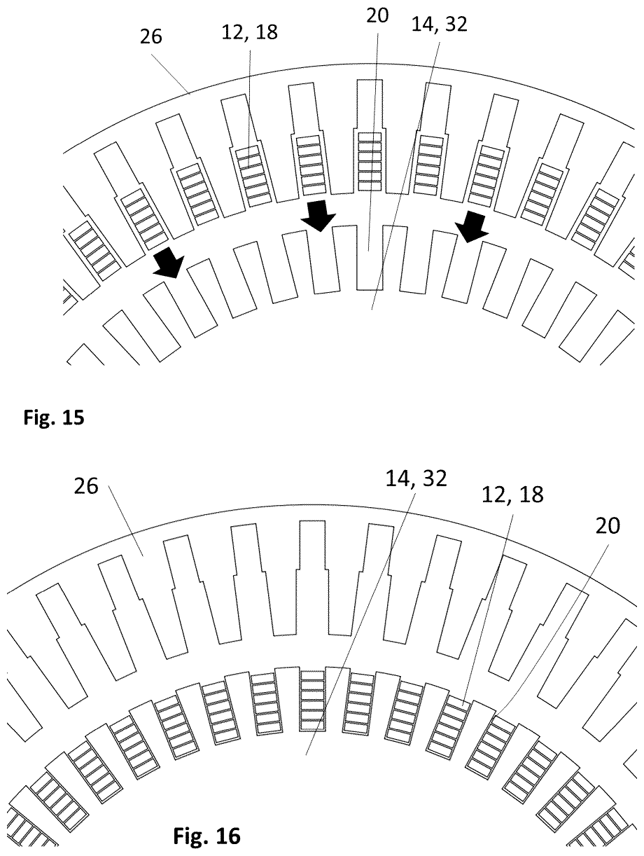

This can also be supported by the support fingers 54, as shown in FIG. 15, but does not have to.

FIGS. 18 and 19 show an embodiment variant. Accordingly, the support fingers 54 can clamp the slot insulations 34 (here formed as Omega-shaped folded paper) when joining the coil mat 12 to the stator 14. This prevents the paper from being displaced into the groove when the wire sections 18 are inserted. For the sake of simplicity, this is shown in FIGS. 18 and 19 with only one support finger 54 and without wires. In the further course of inserting the wire sections 18, in some embodiments, the slot insulations 34 are released again by a corresponding counter-movement of the support fingers 54 in order to enable the slot insulations to be pushed together with the wires down to the slot base of the stator slots 20.

In the following, a second embodiment of the joining method and the joining device 10 are explained with reference to the illustration in FIGS. 2, 8, 9, 20-29.

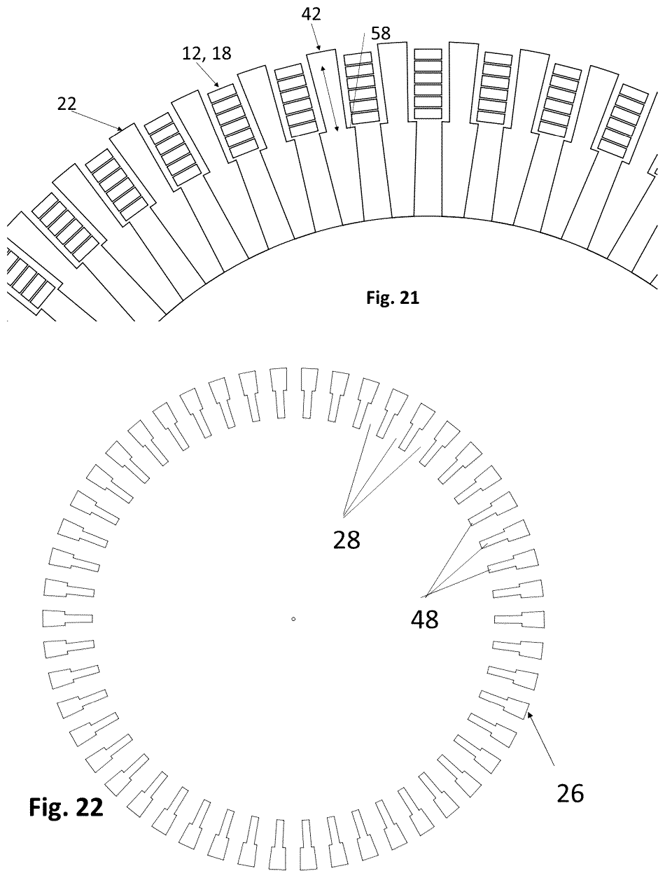

As shown in FIGS. 20 and 21, the winding carrier 22 according to the second embodiment has radially movable winding carrier slot limiting elements 42 (e.g., in the form of lamellae). For example, actuators not shown are provided for this purpose, possibly with transmission, which are controlled by the control unit 40 and which initiate the radial movement of the slot limiting elements 42. In particular, the winding carrier slot limiting elements 42 have a step 58 for forming a part of the respective slot base of the associated winding carrier receiving slot 24.

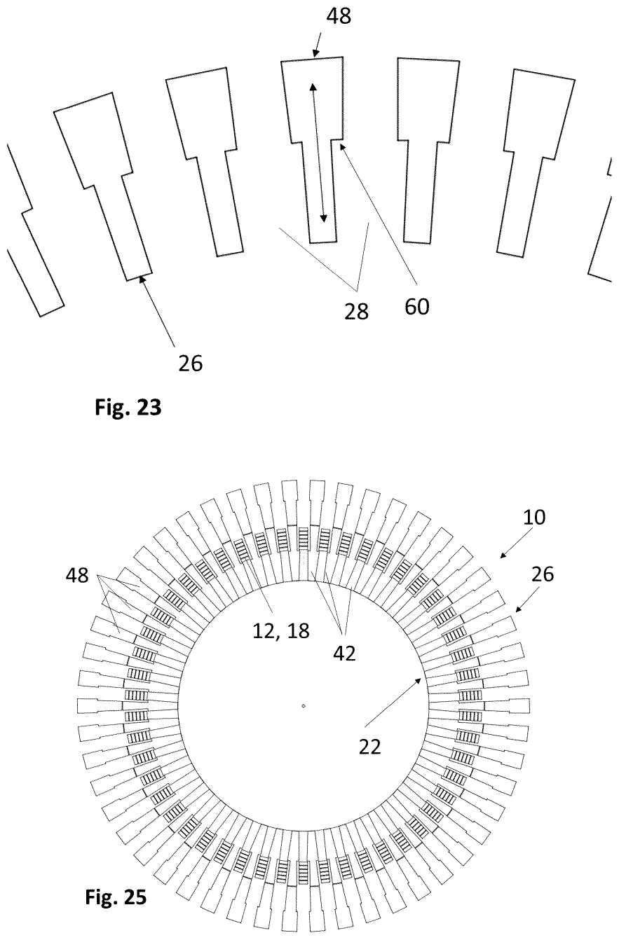

According to FIGS. 22 and 23, the transfer tool slot limiting elements 48 of the transfer tool 26 according to the second embodiment are also radially movable and are designed in particular as lamellae. The radial movement of the transfer tool slot limiting elements 48 is also controlled by the control unit 40. Steps 60 are also provided here, which form part of the slot base of the transfer tool receiving slots 28.

In one embodiment variant, the transfer tool 26 according to the second embodiment can also be used together with the arrangements of support fingers as described above and shown in FIGS. 7 and 17-19.

In the following, a second embodiment of the joining method is explained with reference to the illustration in FIGS. 8, 9, 24a-29.

In a first step, the coil mat 12 is wound up on the winding carrier 22 shown in FIG. 20 in a manner comparable to that shown in FIGS. 8 and 9. In some embodiments, this has a larger diameter than the diameter of the stator 14. In particular, the winding diameter with which the coil mat 12 is wound up on the winding carrier 22 is larger than the stator diameter, so that additional expansion at the transfer tool 26 is not necessary. In preferred embodiments, the winding carrier slot limiting elements 42 are positioned radially for winding so that the winding diameter of the coil mat 12 on the winding carrier 22 corresponds to the receiving diameter of the coil mat 12 on the transfer tool 26 when the latter is put on the stator 14.

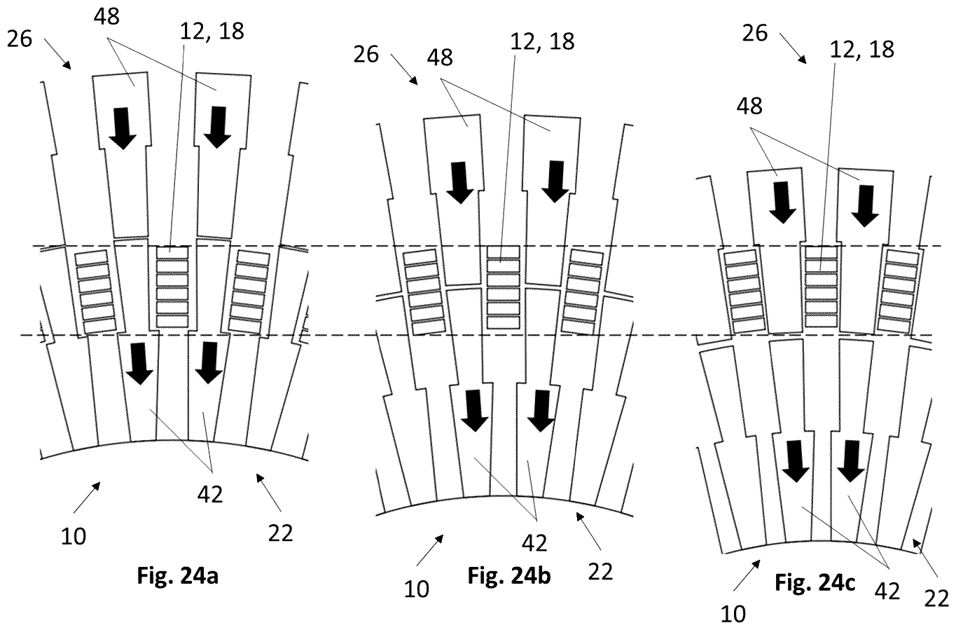

In a second step, which is shown in detail in FIGS. 24a-24c and in an overview in FIGS. 25 to 27, the coil mat 12 is moved from the winding carrier 22 onto the transfer tool 26—preferably with little or no deformation. For this purpose—as already described above for the first embodiment—winding carrier 22 and transfer tool 26 are first arranged concentrically to one another and aligned with their receiving slots 24, 28 to one another.

Then the winding carrier slot limiting elements 42 are moved radially inwards, while at the same time the transfer tool slot limiting elements 48 are moved radially inwards in order to enter between the wire sections 18. Thus, rather than the wire sections 18 not moving or moving only slightly, the slot limiting elements 42, 48 are moved radially to transfer the coil mat 12.

Thus, in some embodiments, wires 12a-12f of the coil winding are transferred from the winding carrier 22 to the transfer tool 26 in such a way that the wires 12a-12f retain the diameter and shape as much as possible. The lamellae of the winding carrier 22 retract and the lamellae of the transfer tool 26 simultaneously retract between the wires 12a-12f. In this way, the coil mat 12 is transferred without having to be deformed.

In addition, elements such as retaining rings on the winding heads 16 (not shown) can prevent the coil mat 12 from slipping during this process of transferring from the winding carrier 22 to the transfer tool 26. It is also possible to use the support fingers 54 during this process.

In a third step, the coil mat 12 is transferred from the transfer tool 26 to the stator 14. For this purpose, the transfer tool 26 and the stator 14 are first arranged concentrically and aligned with their slots 28, 20, as already described above for the first embodiment.

Then, as described above for the first embodiment, the coil mat 12 is transferred from the transfer tool 26 to the stator 14, for example using radially movable grippers, sliders or belts (not shown) which engage the winding heads 16, and is radially compressed in the process. In particular, the diameter of the coil mat 12 is compressed from the larger receiving diameter to the smaller coil diameter with which the coil mat 12 is arranged on the stator 14 as intended.

In some design variants of the second embodiment, the transfer tool slot limiting elements 48 are moved even further radially inwards from the radial position shown in FIG. 20 and thus clamp the slot insulations 34 on the outer circumference of the stator 14 between the stator slots 20 when the wires 12a-12f are inserted into the stator slots 20. Accordingly, the radially displaceable lamellae of the transfer tool 26 can also clamp or hold the paper. Clamping takes place in particular when the wires are inserted; in the further course, the slot insulations 34 can be released again so that they can move together with the wires down to the bottom of the stator slots 20.

In some variants of the second embodiment, the transfer of the coil mat 12 from the transfer tool 26 to the stator 14 is guided by the support fingers 54 as described above for the first embodiment. When used in the second embodiment, the support fingers 54 can also be designed as shown in FIGS. 18 and 19 and hold the slot insulations during transfer.

Accordingly, the movements can be guided by support fingers 54 during transfer: The support fingers 54 prevent damage to the wires 12a-12f at the sharp edges of the laminated core 32.

Although only a single coil mat 12 has been mentioned in the various embodiments, it should be clear that more than one coil mat 12 can be joined to the outer rotor stator 14 using the methods and devices illustrated herein. If several coil mats 12 are used, they can be wound up and transferred together or transferred one after the other.

Further, support fingers 54 may also be associated with the winding carrier 22, for example, a radially movable support finger with an outwardly directed thinner end may be arranged axially adjacent to each winding carrier slot limiting element 42.

A relative movement of the transfer tool and the winding carrier or stator holder can take place in different ways. For example, the transfer tool can be moved with the transfer tool handling device 50, but it can also be held stationary and the relative movement is performed by the other handling devices 46, 38.

In order to improve process reliability in the industrial mass production of stators for external rotor motors, a joining method for joining a coil mat (12) to the stator (14) of an external rotor motor has been described, comprising:
a) providing a coil mat (12) having straight wire sections (18) connected by winding heads (16),
b) providing a stator (14) with stator slots (20) opening radially outwards,
c) winding up the coil mat (12) on a winding carrier (22) which has radially outwardly opening winding carrier receiving slots (24),
d) transferring the coil mat (12) from the winding carrier (22) to a transfer tool (26) which has radially inwardly opening transfer tool receiving slots (28), and
e) transferring the coil mat (12) from the transfer tool (26) to the stator (14).

In addition, a joining device (10), a control unit (40) and a computer program for carrying out the joining method have been described.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 joining device
12 coil mat
12a-12f wire
14 stator
16 winding head
18 straight wire section
20 stator slot
22 winding carrier
24 winding carrier receiving slot
26 transfer tool
28 transfer tool receiving slot
30 rectilinear holder
30a tooth
30b tooth gap
32 laminated core
34 slot insulation
36 stator holder
38 stator handling device
40 control unit
40a processor
40b memory
42 winding carrier slot limiting element
44 wind-up device
46 winding carrier handling device
48 transfer tool slot limiting element
50 transfer tool handling device
52 ejector element
53 slot base
54 support finger
56 projection
58 step
60 step

1. A method for joining a coil mat to a stator of an external rotor motor, the method comprising:
a) providing a coil mat having straight wire sections connected by winding heads,
b) providing a stator with stator slots opening radially outwards,
c) winding up the coil mat on a winding carrier which has radially outwardly opening winding carrier receiving slots into which the straight wire sections are inserted,
d) transferring the coil mat from the winding carrier to a transfer tool which has radially inwardly opening transfer tool receiving slots, the winding carrier receiving slots being aligned with the transfer tool receiving slots and the straight wire sections being transferred from the winding carrier receiving slots into the transfer tool receiving slots, and
e) transferring the coil mat from the transfer tool to the stator, the transfer tool receiving slots being aligned with the stator slots and the straight wire sections being transferred radially inwards from the transfer tool receiving slots into the stator slots.

2. The method according to claim 1, wherein step a) comprises at least one or more of:
a1) bending wires with a substantially rectangular cross-section and an outer insulating layer to form wave winding wires;
a2) joining a plurality of wave winding wires which are meander-shaped with straight wire sections and winding heads bent in different directions therebetween;
a3) producing the coil mat by winding, stacking, braiding or pinning a plurality of wires; and,
a4) providing the coil mat on an elongate holder having a series of teeth with tooth gaps therebetween so that straight wire portions of the coil mat are received in the tooth gaps.

3. The method according to claim 1, wherein step b) comprises at least one or more of:
b1) providing a laminated core with stator slots opening radially outwards;
b2) lining stator slots with slot insulation;
b3) inserting insulating papers into stator slots; and,
b4) covering slot edges with Z-shaped or Omega-shaped slot insulation.

4. The method according to claim 1, wherein step c) comprises at least one or more of:
c1) providing the winding carrier with a diameter that is equal to or greater than a diameter of the stator;
c2) providing the winding carrier with radially movable ejector elements for radially ejecting the coil mat from the winding carrier receiving slots;
c3) providing an arrangement of radially movable support fingers axially adjacent to slot limitations of the winding carrier receiving slots;
c4) providing the winding carrier with radially movable winding carrier slot limiting elements;
c5) picking up the coil mat from a linearly extending holder while rotating the winding carrier and relatively linearly moving the winding carrier and holder; and,
c6) winding up the coil mat on the winding carrier with a winding diameter which is equal to or greater than a coil diameter of the coil mat subsequently inserted into the stator.

5. The method according to claim 1, wherein step d) comprises at least one or more of:
d1) providing the transfer tool with an annular arrangement of radially immovable or radially movable transfer tool slot limiting elements;
d2) providing radially movable support fingers axially adjacent to slot limitations of the transfer tool receiving slots;
d3) radially moving the straight wire sections from the winding carrier receiving slots into the transfer tool receiving slots;
d4) radial expansion of the coil mat during transfer from the winding carrier to the transfer tool with radially outwardly moving ejector elements;
d5) transferring the coil mat while maintaining a coil mat shape, a coil mat diameter, or both by radially moving slot limiting elements of the winding carrier and the transfer tool;
d6) supporting, guiding, or both, the coil mat during transfer with radially feedable support fingers; and
d7) holding the coil mat on the winding heads during transfer.

6. The method according to claim 1, wherein that step e) comprises at least one or more of:
e1) radially compressing the coil mat during transfer onto the stator;
e2) guiding the coil mat during transfer with supporting fingers;
e3) holding, releasing, or both slot insulations when transferring the coil mat onto the stator;
e4) clamping of slot insulations with support fingers; and
e5) holding slot insulations with radially movable slot limiting elements of the transfer tool.

7. A device for joining a coil mat, which has straight wire sections connected by winding heads, into outwardly opening stator slots of a stator of an external rotor motor, the device comprising:
a winding carrier which has an annular arrangement of radially outwardly opening winding carrier receiving slots and on which a coil mat is configured to be wound up under insertion of the straight wire sections into the winding carrier receiving slots;
and
a transfer tool, which has an annular arrangement of inwardly opening transfer tool receiving slots and which is configured to receive the coil mat from the winding carrier and transfer the coil mat to the stator.

8. The device according to claim 7, further comprising:
a rectilinear holder with at least one row of teeth for providing the coil mat, and
a wind-up device for rotating the winding carrier and for relatively moving the winding carrier and the rectilinear holder for winding up the coil mat on the winding carrier.

9. The device according to claim 7, wherein the winding carrier
has radially fixed or radially movable winding carrier slot limiting elements, or
has radially movable ejector elements for radially ejecting the coil mat for transfer to the transfer tool, or
is held on a winding carrier handling device which is configured to insert the winding carrier with wound-up coil mat into the transfer tool and to align the receiving slots of the winding carrier and the transfer tool with one another for transferring the coil mat, or
any combination thereof.

10. The device according to claim 7, wherein the transfer tool
has radially fixed or radially movable transfer tool slot limiting elements, or
is held on a transfer tool handling device which is configured to align the transfer tool with the winding carrier and the stator for the respective transfer of the coil mat, or
is held stationary, with the winding carrier and stator holder being axially movable into the transfer tool, or
any combination thereof.

11. The device according to claim 7, further comprising:
at least one annular arrangement of radially movable support fingers for supporting, or guiding or both the coil mat when transferring from the winding carrier to the transfer tool or from the transfer tool to the stator, or when transferring from the winding carrier to the transfer tool and from the transfer tool to the stator.

12. The device according to claim 11, wherein the at least one annular arrangement of supporting fingers is configured to clamp, release, or both slot insulations inserted in stator slots on the stator when the coil mat is transferred from the transfer tool to the stator.

13. The device according to claim 7, further comprising:
a control unit with at least one processor and at least one memory, the control unit configured to control a joining device for carrying out a joining method.

14. A control unit for a joining device, the control unit configured to control the joining device to perform the joining method according to claim 1.

15. A non-transitory computer readable media storing a computer program comprising instructions for causing a joining device to perform the joining method according to claim 1.
